(19) United States
(12) Patent Application Publication
(10) Pub. No.: US 2002/0126387 A1
(43) Pub. Date: Sep. 12, 2002

(54) Optical multilayer structure material and process for producing the same, light switching device, and image display apparatus

(76) Inventors: Hiroichi Ishikawa, Kanagawa (JP); Takuya Makino, Chiba (JP); Hidenori Watanabe, Kanagawa (JP); Yoshiharu Honjo, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/043,919

(22) Filed: Jan. 8, 2002

(30) Foreign Application Priority Data
Jan. 10, 2001 (JP) P2001-003001

(51) Int. Cl. G02B 5/28

(52) U.S. Cl. 359/578; 359/580; 359/589

(57) ABSTRACT

An optical multilayer structure material has a structure such that, on a substrate, a conductive layer in contact with the substrate, a gap portion having a size that enables an interference phenomenon to occur and can be changed, and an optical thin film are formed in this order. The circumference of a movable portion in the optical thin film is uniformly supported by supporting portions, suppressing generation of strain due to an internal stress. Through holes are formed in the movable portion to allow an etchant to easily reach a sacrifice layer when forming a gap portion by etching for sacrifice layer. There is provided an optical multilayer structure material having a simple construction, which can suppress generation of strain due to an internal stress and can be advantageously used in an image display apparatus.

### CROSS REFERENCES TO RELATED APPLICATIONS

The present document is based on Japanese Priority Document JP 2001-003001, filed in the Japanese Patent Office on Jan. 10, 2001, the entire contents of which being incorporated herein by reference.

### BACKGROUND OF THE INVENTION

1. Field of the Invention

The present invention relates to an optical multilayer structure material having a function of reflecting or transmitting a light and a process for producing the same, and a light switching device and an image display apparatus each using the optical multilayer structure material.

2. Description of the Related Art

In recent years, displays are very important as a display device for image information, and, as a device for the displays, especially as a device for optical communication, optical recording apparatuses, and optical printers, a development of a light switching device (light valve) which operates at a high speed is desired. As conventional devices of this type, there are known one using a liquid crystal, one using a micro mirror (Digital Micro Mirror Device; DMD; registered trademark of Texas Instruments Incorporated), and one using a diffraction grating {grating light valve; GLV; manufactured and sold by Silicon Light Machines (SLM)}.

The GLV comprises a diffraction grating prepared to have a micro electro mechanical systems (MEMS) structure, and realizes a fast light switching device at 10 ns using an electrostatic force. The DMD similarly has an MEMS structure and performs switching by moving a mirror. Displays, such as a projector, can be realized using the above devices, but the liquid crystal and the DMD have a small operation speed. Therefore, for realizing a display as a light valve using the liquid crystal or DMD, the liquid crystals or DMDs must be two-dimensionally arranged, causing the structure of the display to be complicated. On the other hand, the GLV is of a high-speed driven type, and therefore makes it possible to achieve a constitution such that a one-dimensional array of GLVs is scanned to realize a projection display.

However, the GLV has a diffraction grating structure, and it is necessary that six devices be prepared per pixel and that the lights diffracted in two directions be condensed into one by some optical system, thus causing the structure of the display to be complicated.

In this situation, the applicant of the present patent application has previously proposed an optical multilayer structure material having a simple construction and being small and lightweight, which is advantageous not only in that the range of the usable constituent materials is wide, but also in that the optical multilayer structure material can achieve fast response even in a visible light range and can be preferably used in an image display apparatus (see, for example, Japanese Patent Application Nos. 2000-200882, 2000-202831, and 2000-219599).

Among the above techniques proposed, for example, FIG. 1 shows an example of the construction of a light switching apparatus 100 using the optical multilayer structure material disclosed in Japanese Patent Application No. 2000-200882. In the light switching apparatus 100, a plurality (four in FIG. 1) of light switching devices 100A to 100D are arranged in a one-dimensional array form on a transparent substrate 101 comprised of, for example, glass. The arrangement of the light switching devices is not limited to the one-dimensional array form but may be a two-dimensional arrangement. In the light switching apparatus 100, for example, a TiO₂ film 102 is formed in one direction (direction of the devices arranged) on the surface of the transparent substrate 101. On the TiO₂ film 102, for example, an indium-tin oxide (compound oxide film of indium and tin; hereinafter, frequently referred to simply as “ITO”) film 103 is formed.

On the transparent substrate 101, a plurality of Bi₂O₃ films 105 are disposed in a direction perpendicular to the TiO₂ film 102 and the ITO film 103. An ITO film 106 is formed as a transparent conductive film on the outside of the Bi₂O₃ film 105. The ITO film 106 and the Bi₂O₃ film 105 have a bridge structure at a position such that they cross the ITO film 103. A gap portion 104 whose size is changed depending on the switching (on-off) operation is provided between the ITO film 103 and the ITO film 106. When an incident light has a wavelength designated by symbol λ (550 nm), the optical size of the gap portion 104 is changed in the range of, for example, λ/4 (137.5 nm) and 0.

The light switching devices 100A to 100D switch the optical size of the gap portion 104 in the range of, for example, λ/4 and 0 by using an electrostatic attraction force due to a differential potential caused by applying a voltage to the transparent conductive films (ITO films 103, 106). FIG. 1 shows that each of the light switching devices 10A, 100C is in a state such that the size of the gap portion 104 is 0 (i.e., low-reflection state), and each of the light switching devices 100B, 100D is in a state such that the size of the gap portion 104 is λ/4 (i.e., high-reflection state).

In the light switching apparatus 100, when the ITO film 103 is grounded so that the potential becomes 0V and a voltage of, for example, +12V is applied to the ITO film 106, the potential difference caused generates an electrostatic attraction force between the ITO films 103, 106, so that each of the light switching devices 10A, 100C is in a state such that the ITO films 103, 106 adhere to each other, that is, the size of the gap portion 104 is 0. In this state, the incident light P, passes through the light switching device, and further passes through the transparent substrate 101 to become a transmitted light P₂.

Then, the ITO film 106 is grounded so that the potential becomes 0V to remove the electrostatic attraction force between the ITO films 103, 106, so that, as shown in FIG. 1, each of the light switching devices 100B, 100D is in a state such that the ITO films 103, 106 are separated from one another, that is, the size of the gap portion 104 is λ/4. In this state, the incident light P₁ is reflected to become a reflected light P₃.

Thus, in the light switching apparatus 100, in each of the light switching devices 100A to 100D, by binary switching of the size of the gap portion using an electrostatic force, the incident light P₁ can be switched in a binary mode and taken as a state free of a reflected light and a state such that the reflected light P₃ is generated. As mentioned above, the incident light P₁ can also be continuously switched between a state free of reflection and a state such that the reflected light P₃ is generated.

In each of the above optical multilayer structure materials proposed, the optical thin film (membrane) as a movable portion is formed from bismuth oxide (Bi₂O₃) or silicon nitride (Si₃N₄), and has a bridge structure having a plane in a rectangular form, and the two short sides serve as supporting portions and the other two sides (long sides) serve as free ends.

FIG. 2 shows a general form of the cross-sectional construction of a conventional optical multilayer structure material. In the optical multilayer structure material 110, a Cr film 112 is formed as a lower electrode on a glass substrate 111, and an Si₃N₄ film (optical thin film) 113 having a bridge structure is formed on the Cr film 112 through a gap portion 114. In the optical thin film 113, supporting portions 113A, 113B for supporting a movable portion 113C are formed on short sides. On the movable portion 113C, a not shown upper electrode corresponding to the lower electrode is formed.

The optical thin film 113 having a bridge structure is prepared by preliminarily depositing, on a substrate, a not shown sacrifice layer comprised of amorphous silicon or the like, depositing the optical thin film 113 on the sacrifice layer, and then selectively etching the sacrifice layer. In the etching for sacrifice layer, a tensile stress is exerted on the optical thin film 113 as an internal stress of the material. This is because the optical thin film 113 is allowed to tense to improve the flatness of the film and to prevent the movable portion 113C from being in an arched bridge form when a compression stress is exerted on the optical thin film 113.

However, in the optical thin film 113, only the short sides 113A, 113B are fixed ends, and therefore, when the internal stress in the movable portion 113C is an isotropic tensile stress, the movable portion 113C is extended in the longitudinal direction while a tensile stress in the widthwise direction of the movable portion 113C is exerted on the optical thin film 113, leading to a problem in that a phenomenon in which the optical thin film 113 suffers strain in the widthwise direction occurs. A structure such that a gammadion-shaped supporting portion is formed on the optical thin film 113 having a plane in a square form has been proposed (see U.S. Pat. No. 5,500,761). However, it can be easily expected that such an optical thin film also suffers strain due to an internal stress.

### SUMMARY OF THE INVENTION

In view of the above problems, the present invention has been made to provide an optical multilayer structure material having a simple construction, which can suppress generation of strain due to an internal stress, and a process for producing the same.

Further, the present invention also provides a light switching device and an image display apparatus each using the above optical multilayer structure material, which can achieve stable fast response.

The optical multilayer structure material of the present invention has a construction such that an optical multilayer structure material comprises an optical thin film having a bridge structure on a substrate through a gap portion having a size that enables an interference phenomenon to occur, wherein the amount of a light which reflects off, is transmitted by, or is absorbed by the optical thin film is changed depending on the displacement of the optical thin film in a direction perpendicular to the substrate, wherein the optical thin film comprises a movable portion, and a supporting portion for uniformly supporting a circumference of the movable portion by surrounding the gap portion.

The process for producing an optical multilayer structure material of the present invention comprises the steps of: forming, on a substrate, a pattern for a sacrifice layer having a predetermined thickness, and forming an optical thin film so that the optical thin film covers a surface and a sidewall portion of the sacrifice layer and has a through hole for etching which reaches the sacrifice layer; and subjecting the optical thin film to etching via the through hole to selectively remove the sacrifice layer, and forming, in the optical thin film, a movable portion and a supporting portion for uniformly supporting a circumference of the movable portion by surrounding the gap portion.

The light switching device of the present invention comprises: an optical multilayer structure material which comprises an optical thin film having a bridge structure on a substrate through a gap portion having a size that enables an interference phenomenon to occur, wherein the amount of a light which reflects off, is transmitted by, or is absorbed by the optical thin film is changed depending on the displacement of the optical thin film in a direction perpendicular to the substrate; and a driving means for changing the optical size of the gap portion in the optical multilayer structure material, wherein the optical thin film comprises a movable portion, and a supporting portion for uniformly supporting a circumference of the movable portion by surrounding the gap portion.

The image display apparatus of the present invention for displaying a two-dimensional image by radiating a light onto a plurality of light switching devices which are one-dimensionally or two-dimensionally arranged, wherein each of the light switching devices comprises: an optical multilayer structure material which comprises an optical thin film having a bridge structure on a substrate through a gap portion having a size that enables an interference phenomenon to occur, wherein the amount of a light which reflects off, is transmitted by, or is absorbed by the optical thin film is changed depending on the displacement of the optical thin film in a direction perpendicular to the substrate; and a driving means for changing the optical size of the gap portion in the optical multilayer structure material, wherein the optical thin film comprises a movable portion, and a supporting portion for uniformly supporting a circumference of the movable portion by surrounding the gap portion.

In the optical multilayer structure material of the present invention and the process for producing the same, the supporting portion in the optical thin film uniformly supports the circumference of the movable portion and surrounds the whole of the gap portion. Therefore, an occurrence of a phenomenon in which the optical thin film suffers strain in a specific direction is efficiently prevented.

In the light switching device of the present invention, the driving means displaces the movable portion whose circumference is uniformly supported in the optical multilayer structure material to change the optical size of the gap portion, thus making it possible to conduct a switching operation relative to an incident light.

In the image display apparatus of the present invention, a plurality of the light switching devices one-dimensionally or two-dimensionally arranged of the present invention are irradiated with a light to display a two-dimensional image.

As mentioned above, in each of the optical multilayer structure material, the process for producing an optical multilayer structure material, and the light switching device of the present invention, the circumference of the movable portion in the optical thin film is uniformly supported by the supporting portion. Therefore, not only can an occurrence of a phenomenon in which the optical thin film suffers strain in a specific direction be prevented, but also an effect is obtained such that a stable fast response can be achieved.

Especially in the optical multilayer structure material wherein the supporting portion in the optical thin film slopes at an oblique angle to the surface of the substrate as a ground and the conductive layer, the strength of the supporting portion is improved.

In addition, especially in each of the optical multilayer structure material and the process for producing an optical multilayer structure material wherein the optical thin film has, in at least one of the movable portion and the supporting portion, a through hole formed in communication with the sacrifice layer, the etchant can be allowed to easily reach the sacrifice layer, thus making it possible to improve the etching efficiency.

Further, especially in the optical multilayer structure material wherein a recess portion is formed at a position corresponding to a corner portion of the optical thin film, when the movable portion in the optical thin film is in a rectangular form, stress can be prevented from concentrating the four corners of the movable portion.

Furthermore, in the image display apparatus of the present invention, image display is performed by using a light switching apparatus having a one-dimensional or two-dimensional array structure obtained by one-dimensionally or two-dimensionally arranging light switching devices each using the optical multilayer structure material of the present invention. Therefore, an image display apparatus being capable of performing a stable fast response can be realized.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a diagrammatic view showing the construction of one form of the light switching apparatus that the present applicant has previously filed;

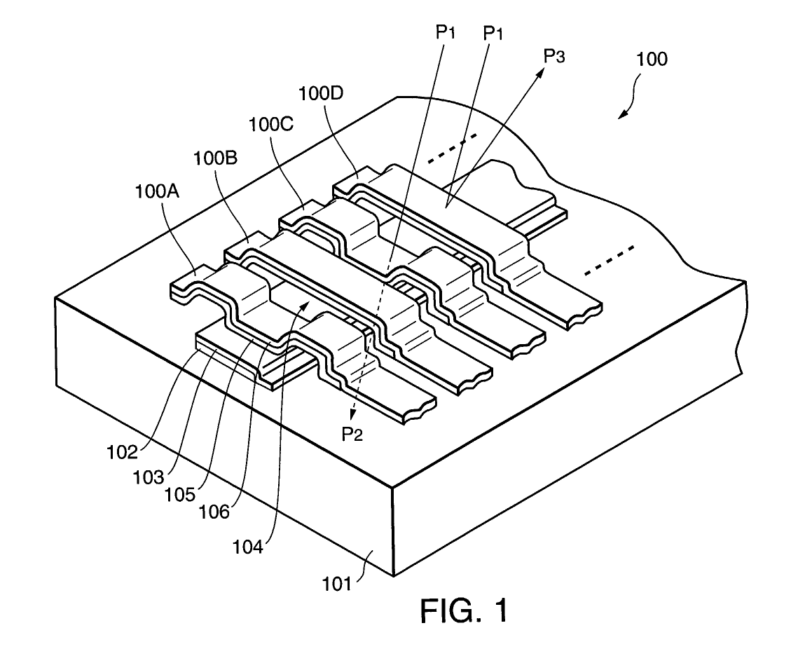

FIG. 2 is a diagrammatic view showing the construction of one form of the optical multilayer structure material in the light switching apparatus shown in FIG. 1;

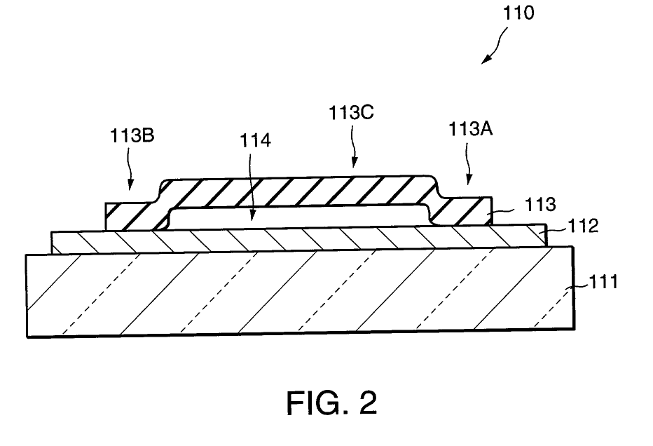

FIG. 3 is a partially broken, diagrammatic perspective view showing the construction of an optical multilayer structure material according to a first embodiment of the present invention;

FIGS. 4A to 4D are diagrammatic cross-sectional views illustrating steps in a process for producing the optical multilayer structure material shown in FIG. 3;

FIGS. 5A to 5C are diagrammatic cross-sectional views illustrating subsequent steps to the step shown in FIG. 4D;

FIG. 6 is a diagrammatic cross-sectional view illustrating a subsequent step to the step shown in FIG. 5C;

FIG. 7 is a diagrammatic perspective view showing a construction of an optical multilayer structure material according to an example of a modification of the first embodiment of the present invention;

FIG. 8 is a diagrammatic perspective view showing the construction of an optical multilayer structure material according to another example of a modification of the first embodiment of the present invention;

FIG. 9 is a partially broken, diagrammatic perspective view showing the construction of an optical multilayer structure material according to a second embodiment of the present invention;

FIG. 10 is a diagrammatic perspective view showing the construction of an optical multilayer structure material according to a third embodiment of the present invention;

FIG. 11A to 11D are diagrammatic cross-sectional views illustrating steps in a process for producing the optical multilayer structure material shown in FIG. 10;

FIG. 12A to 12C are diagrammatic cross-sectional views illustrating subsequent steps to the step shown in FIG. 11D;

FIG. 13A to 13C are diagrammatic cross-sectional views illustrating subsequent steps to the step shown in FIG. 12C;

FIG. 14 is a diagrammatic plan view showing the construction of one form of a light switching apparatus constituted using the optical multilayer structure material according to one example of a modification of the first embodiment of the present invention;

FIG. 15 is a diagrammatic cross-sectional view of the light switching apparatus shown in FIG. 14, taken along XV-XV line;

FIG. 16 is a diagrammatic view showing the construction of one form of a display;

FIG. 17 is a diagrammatic view showing the construction of another form of a display; and

FIG. 18 is a diagrammatic view showing the construction of a paper-form display.

### DETAILED DESCRIPTION OF THE PREFERRED EMBODIMENTS

Hereinbelow, preferred embodiments of the present invention will be described in detail with reference to the accompanying drawings.

[First Embodiment]

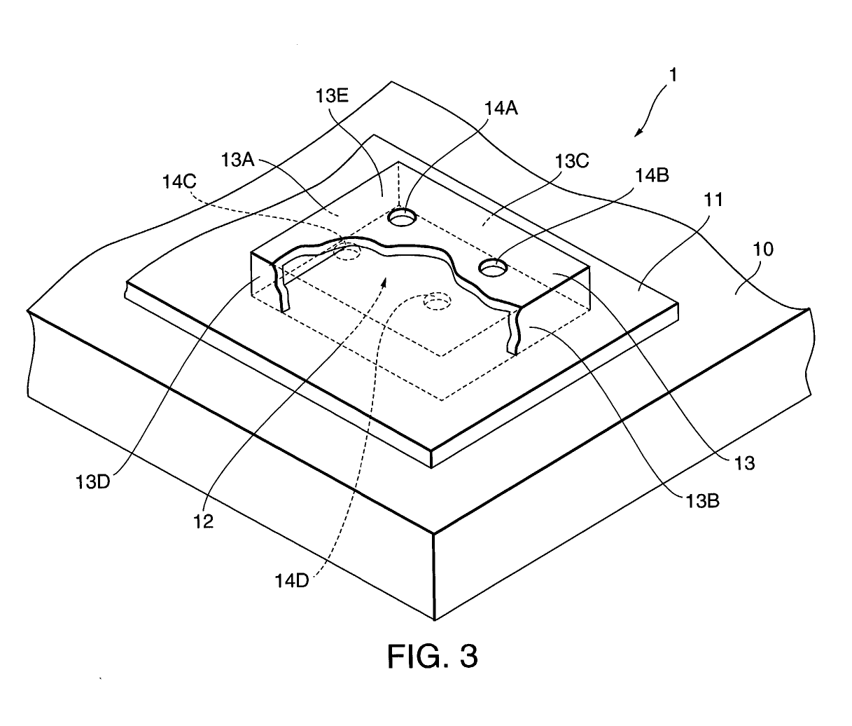

FIG. 3 shows the basic construction of an optical multilayer structure material 1 according to the first embodiment of the present invention. The optical multilayer structure material 1 is specifically used as, for example, a light switching device, and a plurality of the light switching devices are arranged in a one-dimensional array form to constitute an image display apparatus.

The optical multilayer structure material 1 of the present embodiment has a construction such that, on a substrate 10 comprised of a nonmetallic transparent material, such as transparent glass or a transparent plastic, a conductive layer 11 in contact with the substrate 10, a gap portion 12 having a size that enables an interference phenomenon to occur and can be changed, and an optical thin film 13 having a movable portion are formed in this order.

The conductive layer 11 may be a composite layer comprised of a plurality of layers, and has a function as a lower electrode. As examples of materials for the conductive layer 11, there can be mentioned combinations of a dielectric, such as titanium oxide (TiO₂)(n₁=2.4), silicon nitride (Si₃N₄)(n₁=2.0), zinc oxide (ZnO)(n₁=2.0), niobium oxide (Nb₂O₅)(n₁=2.2), tantalum oxide (Ta₂O₅)(n₁=2.1), or silicon oxide (SiO₂)(n₁=2.0), with an electrically conductive material, such as tin oxide (SnO₂)(n₁=2.0), ITO (indium-tin oxide)(n₁=2.0) or other metal, a nitride, or carbon. It is noted that n, herein represents a refractive index of each of the compounds.

The size of the gap portion 12 (the gap between the conductive layer 11 and the optical thin film 13) is changeable by a not shown driving means. A medium for filling the gap portion 12 may be either a gas or a liquid as long as it is transparent. Examples of gases include air {n_{D}=1.0; n_{D}: refractive index relative to the sodium D-line (589.3 nm)} and nitrogen gas (N₂)(n_{D}=1.0), and examples of liquids include water (n_{D}=1.333), silicone oil (n_{D}=1.4 to 1.7), ethyl alcohol (n_{D}=1.3618), glycerin (n_{D}=1.4730), and diiodomethane (n_{D}=1.737). The gap portion 12 may be in a vacuum state.

In the optical thin film 13, the movable portion has a plane, for example, in a rectangular form, and the sidewalls on the four sides respectively function as supporting portions 13A, 13B, 13C, and 13D. In the movable portion 13E in the optical thin film 13, through holes 14A, 14B, 14C, 14D for allowing an etchant to reach a sacrifice layer are formed at, for example, four corners in the below-mentioned step of etching for sacrifice layer. The number of the through holes is arbitrary.

The optical thin film 13 is formed from, for example, silicon nitride (Si₃N₄)(n₂=2.0), silicon oxide (SiO₂)(n₂=1.46), bismuth oxide (Bi₂O₃)(n₂=1.91), magnesium fluoride (MgF₂)(n₂=1.38), or alumina (Al₂O₃)(n₂=1.67). It is noted that n₁ herein represents a refractive index of each of the compounds.

As mentioned below, the optical thin film 13 is displaced up and down by, for example, applying a voltage thereto, and a not shown electrode comprised of ITO (compound oxide film of indium and tin) or the like is formed.

As mentioned above, the conductive layer 11 may be either a single layer or a composite layer, and the optical thin film 13 may be also either a single layer or a composite layer comprising two or more layers having different optical properties.

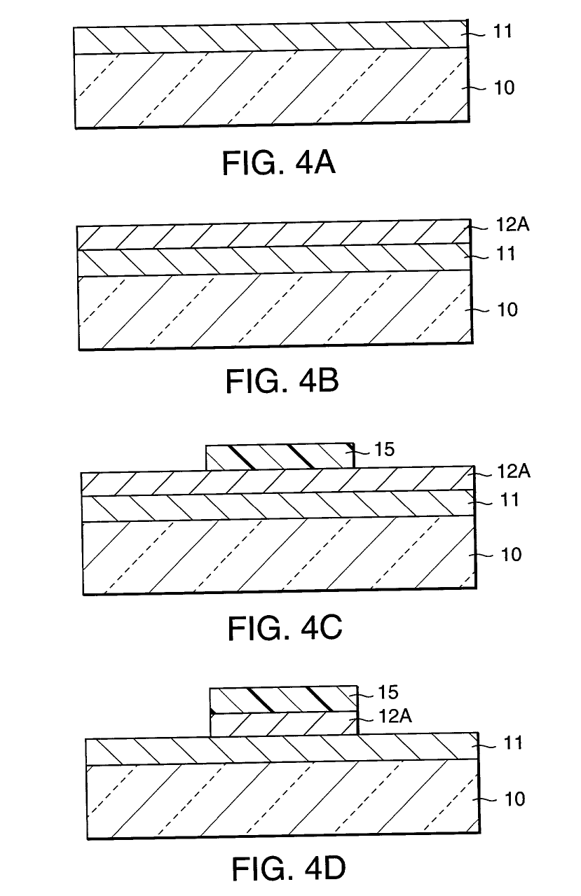

The optical multilayer structure material 1 having the gap portion 12 can be prepared by the production process shown in FIGS. 4A to 6. First, as shown in FIG. 4A, on a substrate 10 comprised of, for example, transparent glass, a conductive layer 11 comprised of TiO₂ containing ITO is deposited by, for example, a sputtering process. Then, as shown in FIG. 4B, as a sacrifice layer, an amorphous silicon (a-Si) film 12A is deposited by, for example, a chemical vapor deposition (hereinafter, frequently referred to simply as “CVD”) process. Subsequently, as shown in FIG. 4C, a photoresist film 15 having a pattern for the gap portion 12 is deposited, and, as shown in FIG. 4D, the amorphous silicon (a-Si) film 12A is selectively removed by, for example, a reactive ion etching (RIE) process using the photoresist film 15 as a mask.

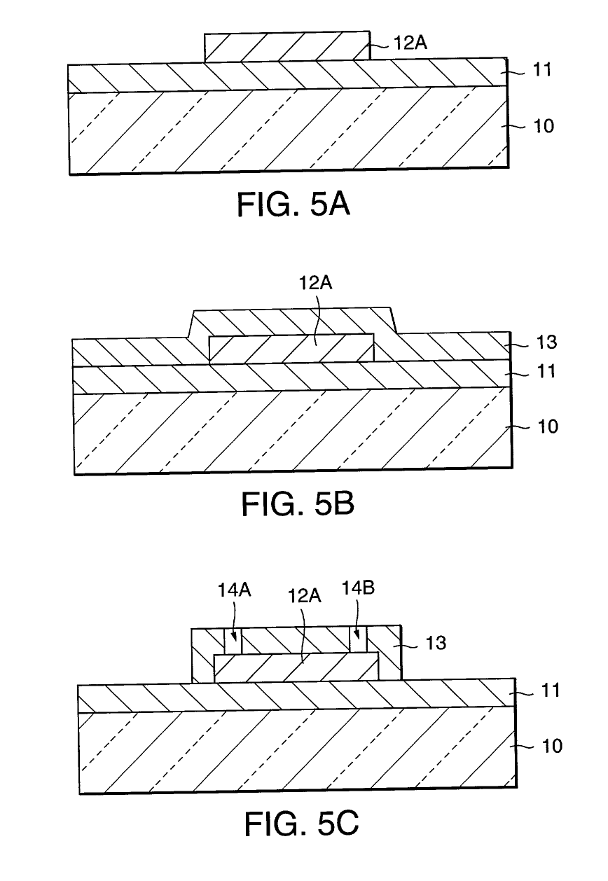

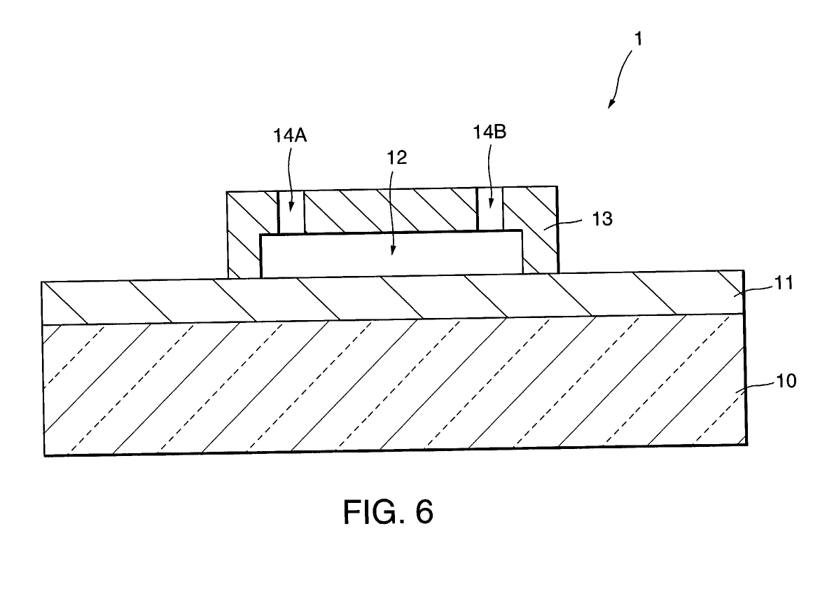

Then, as shown in FIG. 5A, the photoresist film 15 is removed, and then, as shown in FIG. 5B, an optical thin film 13 comprised of Bi₂O₃ is deposited by, for example, a sputtering process. Subsequently, as shown in FIG. 5C, the optical thin film 13 is shaped by, for example, a dry etching process using CF₄ gas into a predetermined shape as shown in FIG. 3 while forming through holes 14A to 14D. Finally, the amorphous silicon (a-Si) film 12A is removed via the through holes 14A to 14D by, for example, a dry etching process using XeF₂ as an etchant. Thus, as shown in FIG. 6, the optical multilayer structure material 1 having therein the gap portion 12 can be prepared.

In the optical multilayer structure material 1 of the present embodiment, the four sides of the movable portion 13E in the optical thin film 13 are respectively supported by the supporting portions 13A to 13D. Therefore, as mentioned above, even when an isotropic tensile stress is exerted on the movable portion 13E, the stress is divided into the four direction equally, thus making it possible to prevent an occurrence of a phenomenon in which strain is caused in the widthwise direction, which phenomenon occurs in a structure such that the movable portion is supported at the two sides. Thus, the optical multilayer structure material 1 having a simple construction which can suppress generation of strain due to an internal stress can be prepared. In addition, the etchant can be brought into contact with the sacrifice layer via the through holes 14A to 14D formed in the movable portion 13E in the optical thin film 13. Therefore, the optical thin film 13 free of strain can be formed by a simple process. Thus, by using the optical multilayer structure material 1, a light switching device and an image display apparatus being capable of performing a stable fast response can be realized.

[Modification]

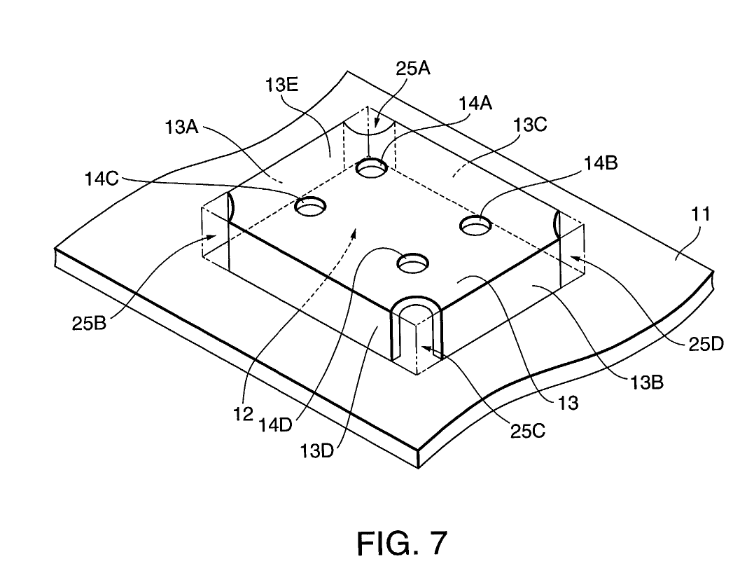

An example of a modification of the first embodiment of the present invention is described below. In the above embodiment, the optical multilayer structure material has a structure such that the four sidewalls of the optical thin film 13 serve as the supporting portions 13A to 13D to prevent strain in the widthwise direction, but, in the present modification, as shown in FIG. 7, recess portions 25A, 25B, 25C, 25D are further formed at positions (corner portions) corresponding to the four corners of the movable portion 13E. By forming the recess portions 25A to 25D, not only can the etchant easily reach the sacrifice layer via the through holes 14A to 14D in the step of etching for sacrifice layer, but also the stress can be prevented from concentrating the four corners of the movable portion 13E.

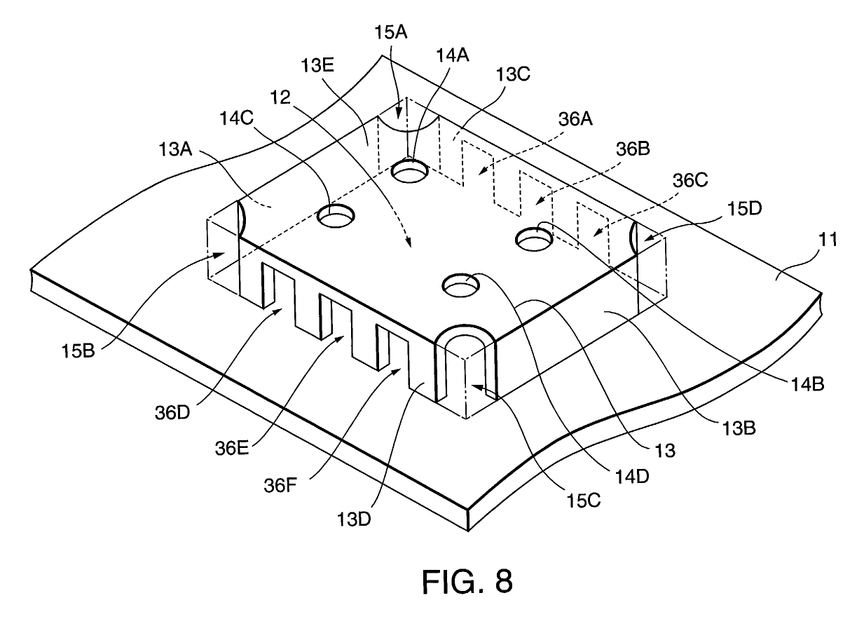

Further, as shown in FIG. 8, the recess portions 15A to 15D are formed at the corner portions of four corners of the movable portion 13E in the optical thin film 13, and further opening portions 36A, 36B, 36C and opening portions 36D, 36E, 36F are formed in the supporting portion 13C and the supporting portion 13D, respectively. Thus, the opening portions 36A to 36F in the supporting portions 13C, 13D serve as window portions in the etching for sacrifice layer, together with the through holes 14A to 14D and the recess portions 15A to 15D in the movable portion 13E, so that the etching efficiency is further improved, and the recess portions 15A to 15D at the corner portions can relax stress concentration.

The number of the opening portions formed in the supporting portions 13C, 13D in the optical thin film 13 is arbitrary, and opening portions may be formed in the supporting portions 13A, 13B.

Hereinbelow, other embodiments of the present invention will be described. In the following embodiments, like parts or portions in the first embodiment are indicated by like reference numerals, and the explanation on such parts or portions is omitted.

[Second Embodiment]

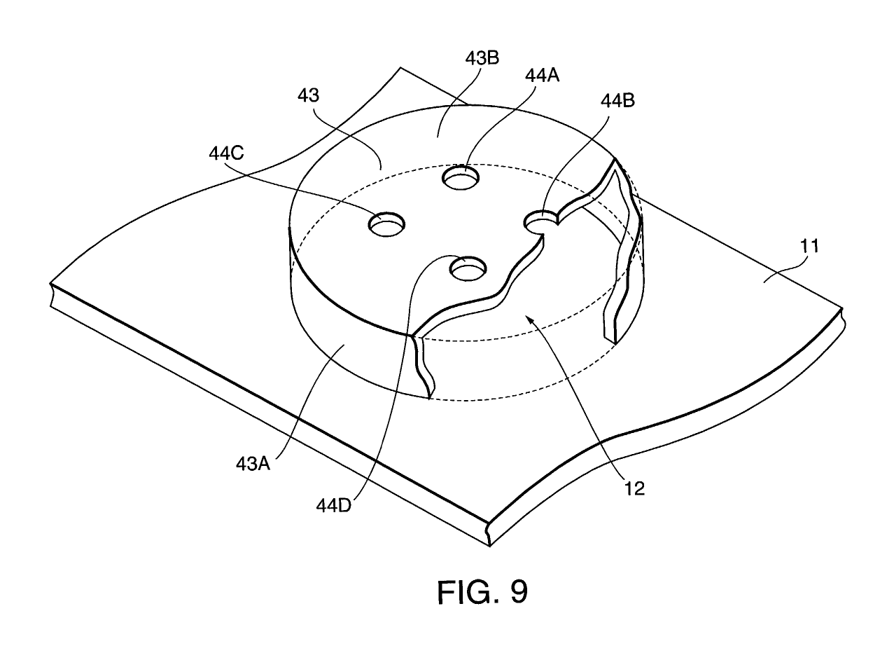

In the present embodiment, as shown in FIG. 9, a movable portion 43B in an optical thin film 43 has a plane in a circular form, and the sidewall of its circumference serves as a supporting portion 43A. The plane form of the movable portion 43B is not limited to the circular form but may be other forms containing a curve, such as an elliptic form and a form such that the two sides in a rectangle are curved. In the movable portion 43B in the optical thin film 43, through holes 44A, 44B, 44C, 44D for allowing the etchant to reach the sacrifice layer are formed in the step of etching for sacrifice layer.

In the present embodiment, the optical thin film 43 has a plane in a circular form. Therefore, the stress is not locally concentrated on a specific portion of the movable portion 43B, and, like in the first embodiment, an optical multilayer structure material having a simple construction which can suppress generation of strain due to an internal stress can be prepared.

In the present embodiment, like in the optical multilayer structure material shown in FIG. 7 or FIG. 8, one or more recess portions or opening portions can be formed in the supporting portion 43A in the optical thin film 43 at any appropriate positions to further improve the efficiency of the step of etching for sacrifice layer.

[Third Embodiment]

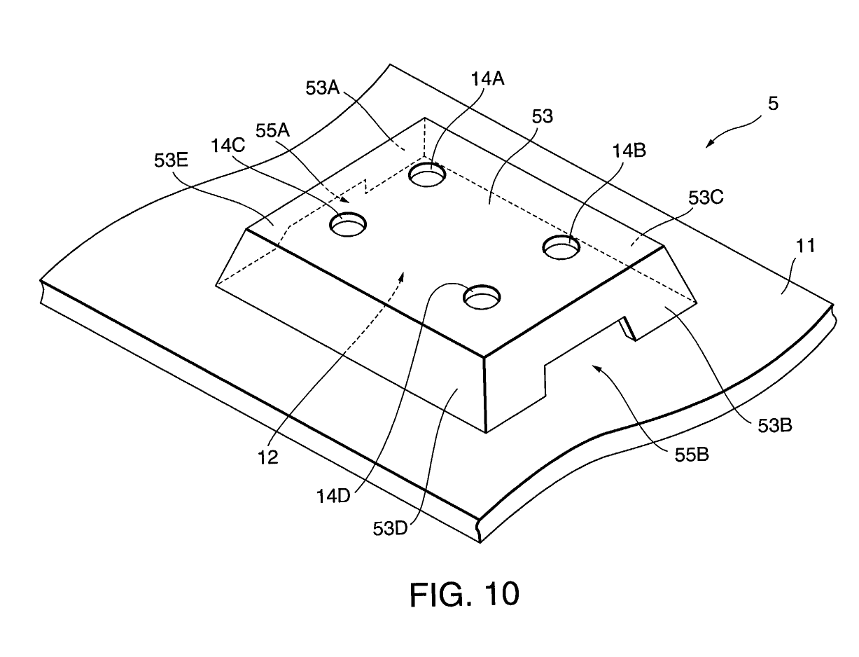

In the present embodiment, as shown in FIG. 10, unlike in the first embodiment, supporting portions 53A, 53B, 53C, 53D of the four sides of an optical thin film 53 in a rectangular form are not perpendicular to the conductive layer 11 but slope at an oblique angle of, for example, about 30°, and they have substantially the same thickness as that of a movable portion 53E. As mentioned above, the optical thin film 53 is deposited by the above-mentioned CVD process or vacuum deposition process and, in the deposition, the probability of particles to be deposited entering the substrate vertically is high, and, when each of the supporting portions 53A to 53D is intended to vertically stand, the amount of the particles deposited to be supporting portions is small, so that the resultant supporting portions have a small thickness, as compared to that of the movable portion 53E, thus causing the strength of the supporting portions to be lowered. By contrast, in the present embodiment, the supporting portions 53A to 53D slope at an oblique angle to the substrate. Therefore, even when the deposition rate of the component in a direction perpendicular to the substrate is high, the thickness of each of the supporting portions 53A to 53D can be satisfactorily secured, so that the strength of the supporting portions 53A to 53D can be increased.

In the supporting portions 53A to 53D, for example, an opening portion 55A and an opening portion 55B may be formed in the supporting portion 53A and the supporting portion 53B, respectively, to allow the etchant to further easily reach the sacrifice layer in the step of etching for sacrifice layer. The opening portions 55A, 55B are not necessarily formed.

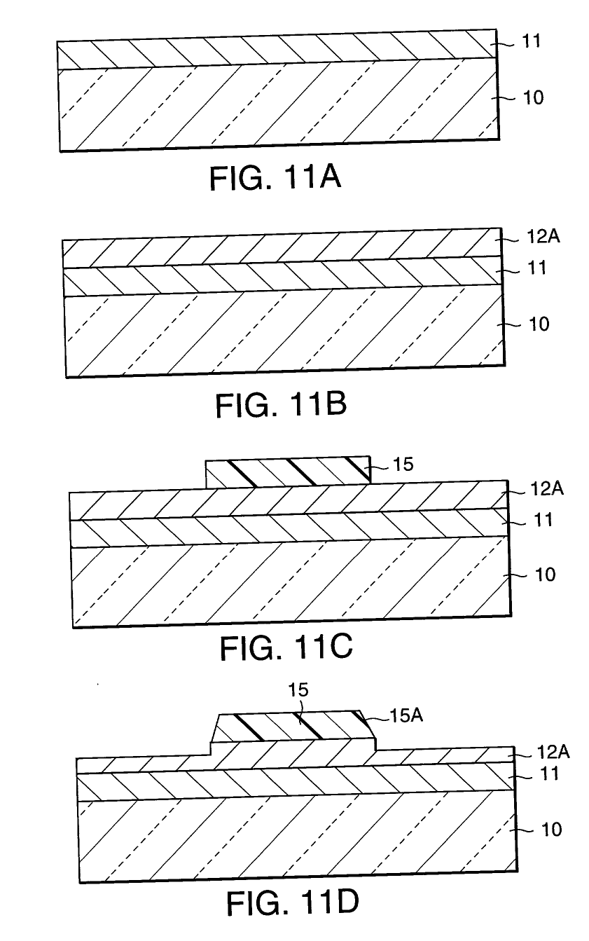

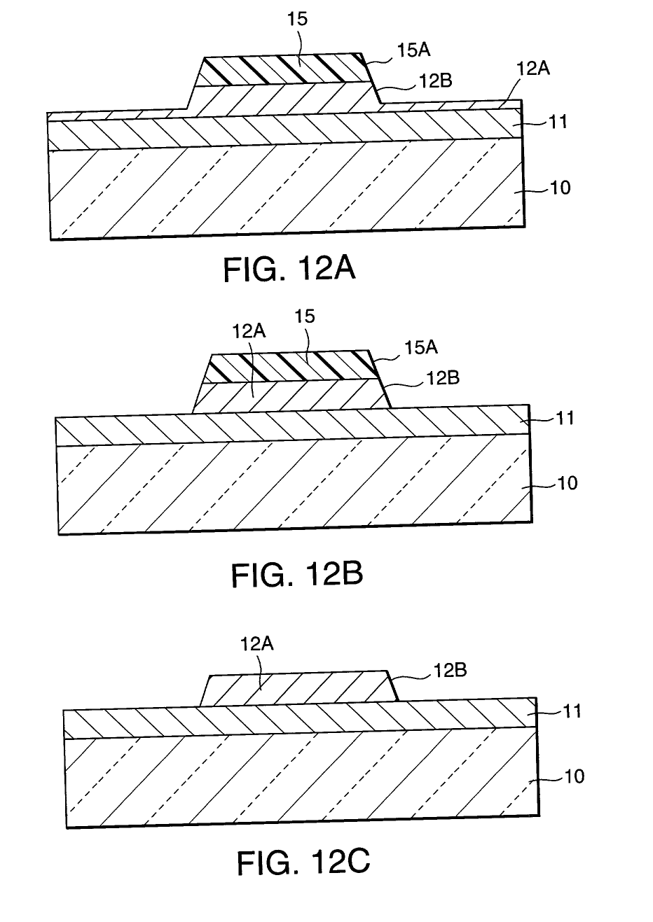

The optical multilayer structure material 5 can be prepared by the production process shown in FIGS. 11A to 13C. First, as shown in FIG. 11A, on a substrate 10 comprised of, for example, transparent glass, a conductive layer 11 comprised of TiO₂ containing ITO is deposited by, for example, a sputtering process, and then, as shown in FIG. 11B, an amorphous silicon (a-Si) film 12A is deposited as a sacrifice layer by, for example, a plasma CVD process. Subsequently, as shown in FIG. 11C, a photoresist film 15 having a pattern for the gap portion 12 is deposited, and, as shown in FIG. 11D, the amorphous silicon film 12A is selectively removed by, for example, a dry etching process using SF₆ or CF₄ and O₂ using the photoresist film 15 as a mask. In this etching process, the photoresist film 15 is etched, together with the amorphous silicon film 12A. In this instance, the amorphous silicon film 12A is slightly reduced in thickness, and the sidewall 15A of the photoresist film 15 is tapered. As etching proceeds, as shown in FIG. 12A, not only the sidewall 15A of the photoresist film 15 but also the sidewall 12B of the amorphous silicon film 12A slope, so that, as shown in FIG. 12B, an island portion is finally formed such that both the sidewall 15A of the photoresist film 15 and the sidewall 12B of the amorphous silicon film 12A slope.

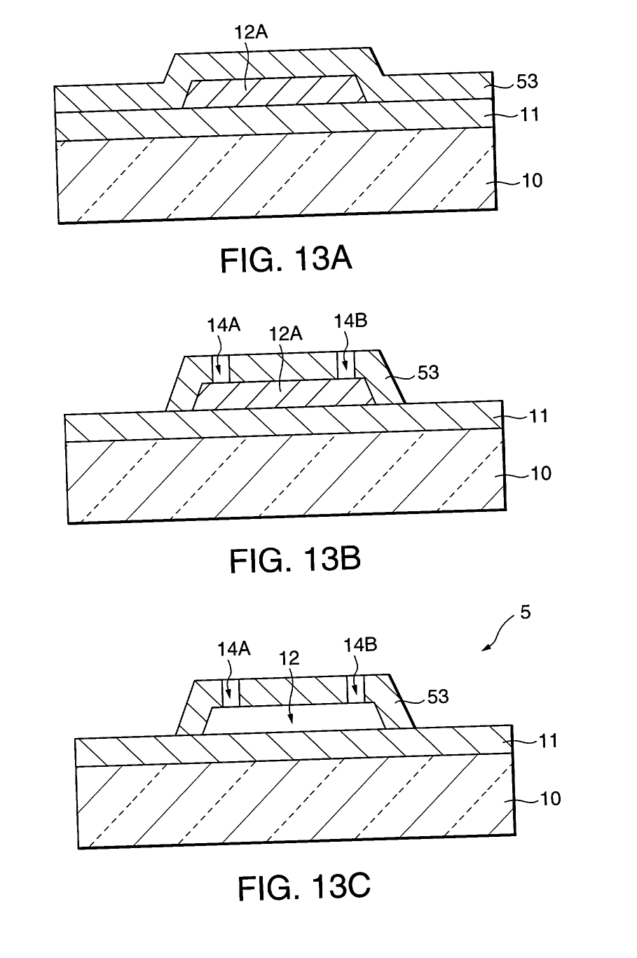

Then, as shown in FIG. 12C, the photoresist film 15 is removed, and then, as shown in FIG. 13A, an optical thin film 53 comprised of Bi₂O₃ is deposited by, for example, a sputtering process. Subsequently, as shown in FIG. 13B, the optical thin film 53 is shaped by, for example, a dry etching process using CF₄ gas into a predetermined shape as shown in FIG. 10 while forming through holes 14A to 14D and opening portions 55A, 55B. Finally, the amorphous silicon film 12A is removed by, for example, a dry etching process using XeF₂ as an etchant. Thus, as shown in FIG. 13C, the optical multilayer structure material 5 having the gap portion 12 can be prepared.

In the optical multilayer structure material 5 of the present embodiment, the supporting portions 53A to 53D in the optical thin film 53 are formed so as to individually slope at an oblique angle to the ground. Therefore, not only can the strength of the supporting portions 53A to 53D be improved, but also the function of the supporting portions 53A to 53D, i.e., the function of preventing an occurrence of a phenomenon in which the optical thin film 53 suffers strain in a specific direction can be further improved. Thus, the optical multilayer structure material 5 having a simple construction which can suppress generation of strain due to an internal stress can be prepared. In addition, the etchant can be easily brought into contact with the sacrifice layer via the through holes 14A to 14D and the opening portions 55A, 55B formed in the optical thin film 53. Therefore, the optical thin film 53 free of strain in the widthwise direction can be formed by a simple process. Thus, by using the optical multilayer structure material 5, a light switching device and an image display apparatus being capable of performing a stable fast response can be realized.

[Light Switching Apparatus]

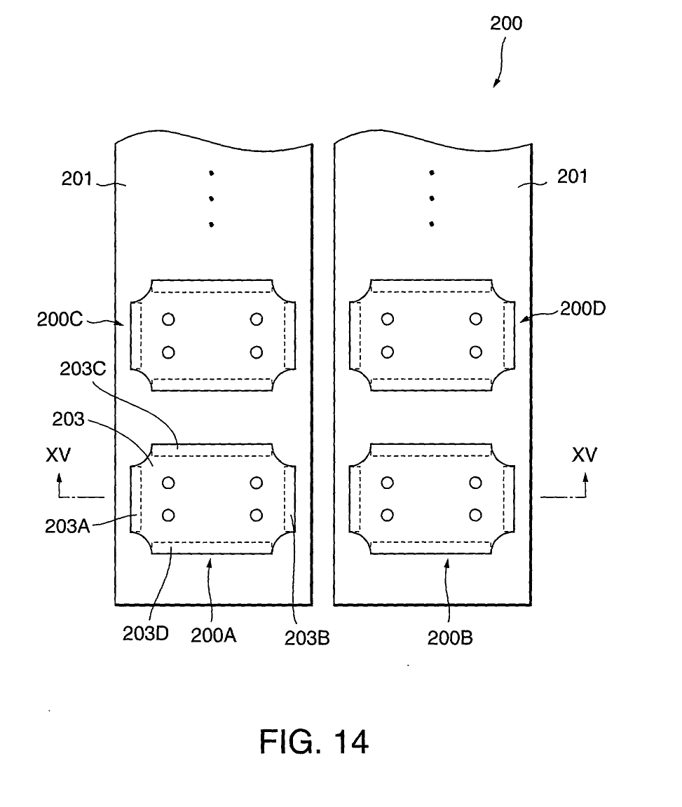

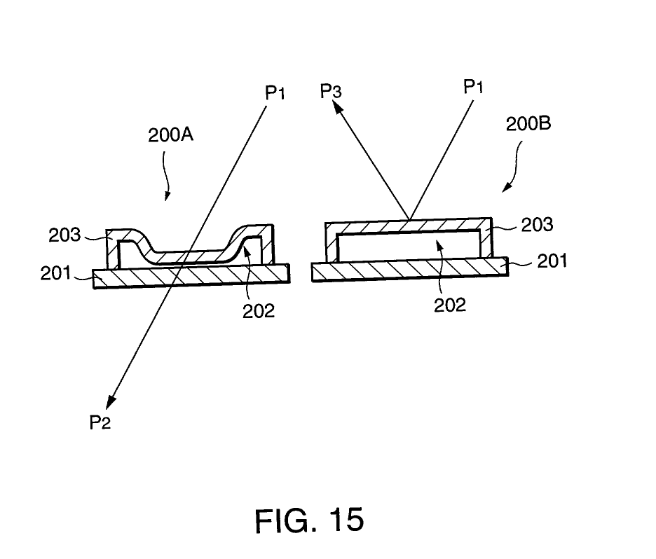

FIGS. 14 and 15 show the construction of a light switching apparatus 200 using, for example, the optical multilayer structure material (see FIG. 7) according to the first embodiment of the present invention. The light switching apparatus 200 comprises a plurality (four in FIG. 14) of light switching devices 200A to 200D arranged in a two-dimensional array form on a not shown substrate comprised of, for example, transparent glass. The arrangement of the light switching devices is not limited to the two-dimensional array form but may be a one-dimensional arrangement. In addition, as the optical multilayer structure material constituting the light switching apparatus 200, the above-described optical multilayer structure material having another structure may be used.

In the light switching apparatus 200, a plurality of conductive layers 201 insulated from one another are formed on the surface of a not shown substrate comprised of, for example, transparent glass. A plurality of optical thin films 203 are respectively formed on each of the conductive layers 201. A gap portion 202 (see FIG. 15) whose size is changed depending on the switching (on-off) operation is provided between the conductive layer 201 and the optical thin film 203. When an incident light has a wavelength designated by symbol λ (550 nm), the optical size (in other words, optical film thickness) of the gap portion 202 is changed in the range of, for example, λ/4 (137.5 nm) and 0.

The light switching devices 200A to 200D switch the optical size of the gap portion 202 in the range of, for example, λ/4 and 0 by using an electrostatic attraction force due to a potential difference caused by applying a voltage to the conductive layer 201 and the optical thin film 203. FIG. 15 shows that each of the light switching devices 200A, 200C is in a state such that the size of the gap portion 202 is 0 (i.e., low-reflection state), and each of the light switching devices 200B, 200D is in a state such that the size of the gap portion 202 is λ/4 (i.e., high-reflection state). The conductive layer 201 and the optical thin film 203 as well as a voltage applying apparatus (not shown) constitute the “driving means” in the present invention.

In the light switching apparatus 200, when the conductive layer 201 is grounded so that the potential becomes 0V and a voltage of, for example, +12V is applied to the optical thin film 203, the potential difference caused generates an electrostatic attraction force between the conductive layer 201 and the optical thin film 203, so that, as shown in FIG. 15, the light switching device 200A is in a state such that the optical thin film 203 is substantially in contact with the conductive layer 201, that is, the size of the gap portion 202 is 0. In this state, the incident light P₁ passes through the optical multilayer structure material, and further passes through the substrate to become a transmitted light P₂.

Then, the optical thin film 203 is grounded so that the potential becomes 0V to remove the electrostatic attraction force between the conductive layer 201 and the optical thin film 203, so that, as shown in FIG. 15, the light switching device 200B is in a state such that the conductive layer 201 and the optical thin film 203 are separated from each other, that is, the size of the gap portion 202 is λ/4. In this state, the incident light P₁ is reflected to become a reflected light P₃.

Thus, in the present embodiment, in each of the light switching devices 200A to 200D, by binary switching of the size of the gap portion using an electrostatic force, the incident light P₁ can be switched in the two directions and taken as the transmitted light P₂ and the reflected light P₃. As mentioned above, the incident light P₁ can also be continuously switched between the transmitted light P₂ and the reflected light P₃ by continuously changing the size of the gap portion.

In each of the light switching devices 200A to 200D, the four sides of the movable portion in the optical thin film 203 are respectively supported by supporting portions 203A, 203B, 203C, and 203D. Therefore, the optical thin film 203 suffers no strain in a specific direction, thus making it possible to realize a light valve for display which can perform a stable fast response.

In addition, in the present embodiment, a plurality of light switching devices located per pixel can be independently driven. Therefore, when a gradation display for image display is conducted as an image display apparatus, the gradation display can be conducted not only by a time sharing system but also by area.

In the example shown in FIG. 14, the light switching devices 200A to 200D are arranged so that they are separated from one another, but, when the light switching devices have a construction such that the adjacent movable portions share a supporting portion, they can be close to one another to increase the aperture ratio.

[Image Display Apparatus]

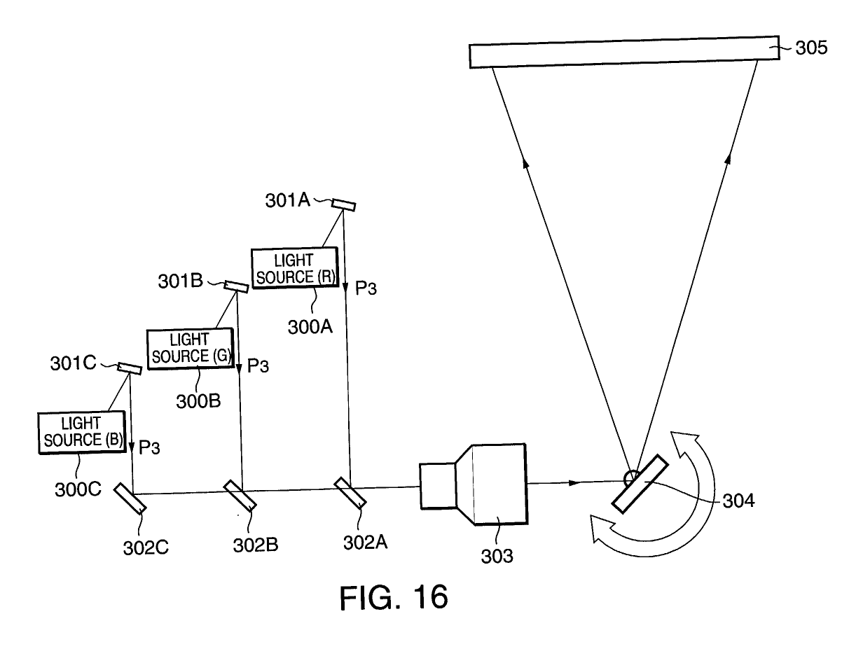

FIG. 16 shows the construction of a projection display as one form of an image display apparatus using the light switching apparatus 200. Here, explanation is made on an example in which the reflected lights P₃ from the light switching devices 200A to 200D are used in image display.

The projection display comprises light sources 300A, 300B, 300C which are respectively comprised of red (R), green (G), and blue (B) lasers, light switching device arrays 301A, 301B, 301C which are respectively provided for the corresponding light sources, dichroic mirrors 302A, 302B, 302C, a projection lens 303, a galvano mirror 304 as a uniaxial scanner, and a projection screen 305. Other than red, green, and blue, the three primary colors may be cyan, magenta, and yellow. In each of the switching device arrays 301A, 301B, 301C, a plurality, i.e., the number of pixels required, for example, 1,000 of the switching devices are one-dimensionally arranged in a direction perpendicular to the paper surface to constitute a light valve.

In the projection display, the lights from RGB colors of the light source 300A, 300B, and 300C enter the light switching device arrays 301A, 301B, 301C, respectively. The incident angle of each of the lights is 0 as close as possible so that there is no effect of polarization, and it is preferred that the lights vertically enter the light switching device arrays. Reflected lights P₃ from the light switching devices are condensed toward the projection lens 303 by the dichroic mirrors 302A, 302B, and 302C. The light condensed in the projection lens 303 is scanned by the galvano mirror 304, and projected onto the projection screen 305 as a two-dimensional image.

Thus, in the projection display, a plurality of light switching devices are one-dimensionally arranged and irradiated with RGB color lights individually, and the light obtained by switching is scanned by a uniaxial scanner, thereby displaying a two-dimensional image.

Further, in the present embodiment, as the light switching devices constituting each of the light switching device arrays 300A to 300C, the optical multilayer structure material of the present invention is used. Therefore, as mentioned above, the four sides of the movable portion in the optical thin film are supported by the supporting portions (sidewalls), preventing an occurrence of a phenomenon in which the optical thin film suffers strain in a specific direction. Thus, a projection display being capable of performing a stable fast response can be realized.

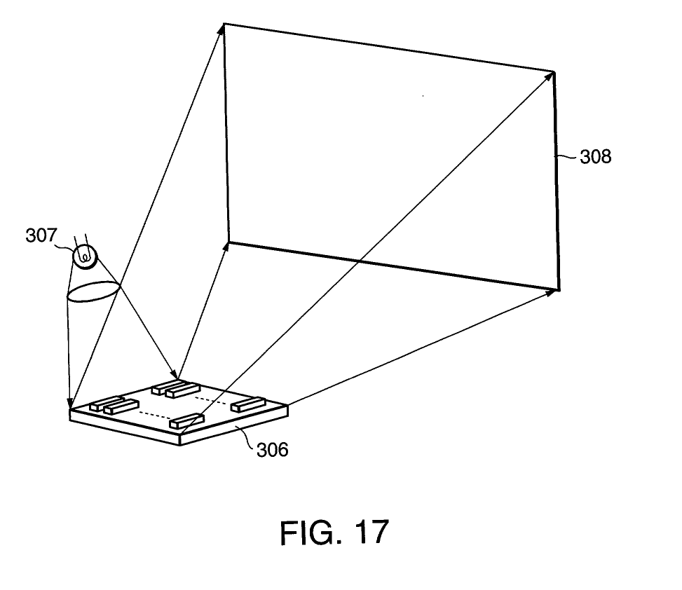

Hereinabove, the present invention is explained with reference to the embodiments and modifications, but the present invention is not limited to the above embodiments and modifications but can be variously modified. For example, in the above embodiment, explanation is made on the display having a construction such that light valves in a one-dimensional array form are scanned using a laser as a light source, but, as shown in FIG. 17, the display can have a construction such that a light switching apparatus 306 having a two-dimensional arrangement is irradiated with a light from a white light source 307 to project an image onto a projection screen 308. As the light source, a light emission diode or the like may be used.

Further, in the above embodiments, explanation is made on an example of a method using an electrostatic force as driving means for the optical multilayer structure material, but a method using a piezoelectric device and a method utilizing a magnetic force can also be applied. As an example of the method utilizing a magnetic force, there can be mentioned a method in which a magnetic layer having an opening portion at a position where a light enters is formed on an optical thin film and an electromagnetic coil is formed under the substrate, and the electromagnetic coil is on-off switched to switch the size of a gap portion between, for example, λ/4 and 0, thus changing the reflection ratio.

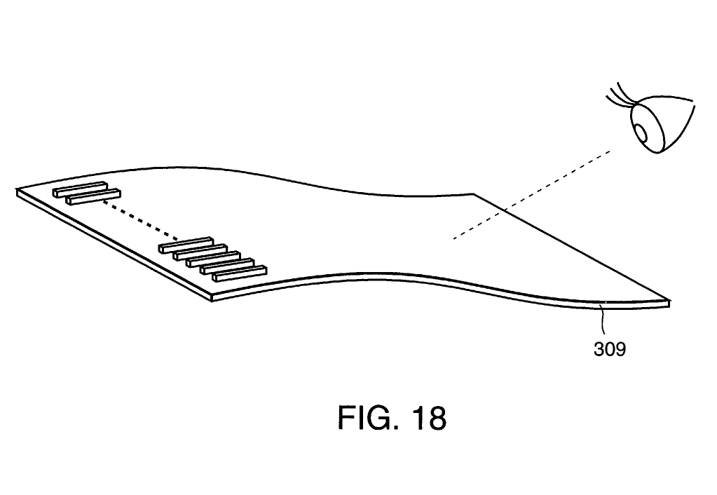

Further, in the above embodiments, explanation is made on an example in which a transparent glass substrate is used as a substrate, but an opaque substrate may be used. In addition, each of the conductive layers 11, 201 may be either transparent or opaque. Further, as shown in FIG. 18, the display may be in a paper form using a substrate 309 having a thickness of, for example, 2 mm or less and having flexibility (being flexible), and the image on the display can be seen by direct vision.

Further, in the above embodiments, explanation is made on an example using the optical multilayer structure material of the present invention in a display, but the optical multilayer structure material can be applied to various devices other than the display, such as an optical printer, for example, it can be applied to an optical printer so that an image is drawn on a photosensitive drum.

What is claimed is:

1. An optical multilayer structure material comprising an optical thin film having a bridge structure on a substrate through a gap portion having a size that enables an interference phenomenon to occur, wherein an amount of a light which reflects off, is transmitted by, or is absorbed by said optical thin film is changed depending on displacement of said optical thin film in a direction perpendicular to said substrate,
said optical thin film comprising a movable portion, and a supporting portion for uniformly supporting a circumference of said movable portion by surrounding said gap portion.

2. The optical multilayer structure material according to claim 1, further comprising, as one electrode, a conductive layer formed so as to be in contact with said substrate, wherein said optical thin film is formed as another electrode at a position opposite to said conductive layer.

3. The optical multilayer structure material according to claim 1, wherein said movable portion in said optical thin film has a plane in a rectangular form.

4. The optical multilayer structure material according to claim 1, wherein said movable portion in said optical thin film has a plane in a circular form.

5. The optical multilayer structure material according to claim 1, wherein said movable portion in said optical thin film has a plane in an elliptic form.

6. The optical multilayer structure material according to claim 1, wherein said supporting portion in said optical thin film slopes at an oblique angle to the surface of said substrate.

7. The optical multilayer structure material according to claim 1, wherein said optical thin film has, in at least one of said movable portion and said supporting portion, a through hole in communication with said gap portion.

8. The optical multilayer structure material according to claim 3, wherein said optical thin film further comprises a recess portion at a position corresponding to each of corner portions of said movable portion in a rectangular form in said optical thin film.

9. The optical multilayer structure material according to claim 2, wherein at least one of said conductive layer and said optical thin film is a composite layer comprising two or more layers having different optical properties.

10. The optical multilayer structure material according to claim 2, further comprising driving means for changing an optical size of said gap portion, wherein said driving means changes the size of said gap portion to change the amount of a light which reflects off or is transmitted by said optical thin film with respect to a light entering from the side of said substrate or the side opposite to said substrate.

11. The optical multilayer structure material according to claim 9, wherein said driving means changes the optical size of said gap portion by using an electrostatic force generated by applying a voltage to said conductive layer and said optical thin film.

12. The optical multilayer structure material according to claim 9, wherein said driving means changes the optical size of said gap portion by using a magnetic force.

13. A process for producing an optical multilayer structure material which comprises an optical thin film having a bridge structure on a substrate through a gap portion having a size that enables an interference phenomenon to occur, wherein an amount of a light which reflects off, is transmitted by, or is absorbed by said optical thin film is changed depending on displacement of said optical thin film in a direction perpendicular to said substrate,
said process comprising the steps of:
forming, on a substrate, a pattern for a sacrifice layer having a predetermined thickness, and forming an optical thin film so that the optical thin film covers a surface and a sidewall portion of said sacrifice layer and has a through hole for etching which reaches said sacrifice layer; and
subjecting the optical thin film to etching via said through hole to selectively remove said sacrifice layer, and forming, in said optical thin film, a movable portion and a supporting portion for uniformly supporting a circumference of said movable portion by surrounding said gap portion.

14. The process according to claim 13, wherein said optical thin film has a plane in a rectangular form, and wherein said process further comprises a step of forming a recess portion for stress relaxation at a position corresponding to each of corner portions of said optical thin film in a rectangular form.

15. A light switching device comprising:
an optical multilayer structure material which comprises an optical thin film having a bridge structure on a substrate through a gap portion having a size that enables an interference phenomenon to occur, wherein an amount of a light which reflects off, is transmitted by, or is absorbed by said optical thin film is changed depending on displacement of said optical thin film in a direction perpendicular to said substrate; and
driving means for changing the optical size of said gap portion in said optical multilayer structure material, wherein:
said optical thin film comprising a movable portion, and a supporting portion for uniformly supporting a circumference of said movable portion by surrounding said gap portion.

16. The light switching device according to claim 15, wherein a plurality of said optical multilayer structure materials are arranged in a one-dimensional array form.

17. The light switching device according to claim 15, wherein a plurality of said optical multilayer structure materials are arranged in a two-dimensional array form.

18. An image display apparatus for displaying a two-dimensional image by irradiating with a light a plurality of light switching devices which are one-dimensionally or two-dimensionally arranged,
each of said light switching devices comprising:
an optical multilayer structure material which comprises an optical thin film having a bridge structure on a substrate through a gap portion having a size that enables an interference phenomenon to occur, wherein the amount of a light which reflects off, is transmitted by, or is absorbed by said optical thin film is changed depending on the displacement of said optical thin film in a direction perpendicular to said substrate; and
driving means for changing the optical size of said gap portion in said optical multilayer structure material,
said optical thin film comprising a movable portion, and a supporting portion for uniformly supporting a circumference of said movable portion by surrounding said gap portion.
